(19) United States
(12) Patent Application Publication
(10) Pub. No.: US 2022/0398468 A1
(43) Pub. Date: Dec. 15, 2022

(54) PREDICTING CHANGES IN MICROCLIMATES BASED ON PHYSICAL STRUCTURE AND INTERNAL/EXTERNAL CONDITIONS

(71) Applicant: Kyndryl, Inc., New York, NY (US)

(72) Inventors: Garfield W. Vaughn, South Windsor, CT (US); Syed Wahid, Brno (CZ); Sandeep Parande, Morrisville, NC (US); Yahia Chemlal, Brno (CZ)

(21) Appl. No.: 17/303,840

(22) Filed: Jun. 9, 2021

(51) Int. Cl. G06N 5/04; G06N 20/00

(52) U.S. Cl. CPC G06N 5/04; G06N 20/00

(57) ABSTRACT

According to one embodiment, a method, computer system, and computer program product for adjusting a microclimate of a structure. The embodiment may include assigning a best-fit microclimate profile for the structure. The embodiment may include identifying heat sources of the structure and respective activity patterns of each identified heat source. The embodiment may include correlating each identified activity pattern to a respective temperature influence on the microclimate. The embodiment may include adjusting a thermostat of the structure based on the identified activity patterns with correlated temperature influences and other factors. The thermostat controls temperature settings for the microclimate.

### BACKGROUND

The present invention relates generally to the field of computing, and more particularly to smart thermostat applications.

Smart thermostats are thermostats that can be used within home automation systems and are responsible for controlling a home's heating, ventilation, and air conditioning. They perform similar functions as a programmable thermostat as they allow a user to control the temperature of the microclimate of their home throughout the day using a schedule, but they also contain additional features, such as sensors and WiFi connectivity, that improve upon energy consumption issues associated with programmable thermostats. Smart thermostats are connected to the Internet, thus enabling users to adjust temperature settings from other internet-connected devices, such as a laptop or a smartphone. This allows users to control a smart thermostat remotely and promotes an ease of use which is essential for ensuring energy savings. In recent years, many housing corporations and smart thermostat developers have realized the potential of smart thermostats to save energy and have developed programs to advance sustainability through smarter technology.

### SUMMARY

According to one embodiment, a method, computer system, and computer program product for adjusting a microclimate of a structure. The embodiment may include assigning a best-fit microclimate profile for the structure. The embodiment may include identifying heat sources of the structure and respective activity patterns of each identified heat source. The embodiment may include correlating each identified activity pattern to a respective temperature influence on the microclimate. The embodiment may include adjusting a thermostat of the structure based on the identified activity patterns with correlated temperature influences and other factors. The thermostat controls temperature settings for the microclimate.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a microclimate profile learning process according to at least one embodiment.

FIG. 3 illustrates an operational flowchart for adjusting thermostat settings of a microclimate in a microclimate temperature analyzation process according to at least one embodiment.

FIG. 4 is a functional block diagram of internal and external components of computers and servers depicted in FIG. 1 according to at least one embodiment.

FIG. 5 depicts a cloud computing environment according to an embodiment of the present invention.

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for adjusting a smart thermostat. The following described exemplary embodiments provide a system, method, and program product to, among other things, identify characteristics of a physical structure and the effects of various heat sources on a microclimate of the physical structure and, accordingly, adjust thermostat settings of the microclimate so as to achieve and/or maintain a desired temperature. Therefore, the present embodiment has the capacity to improve the technical field of smart thermostat applications by dynamically adjusting temperature settings based on physical structure response to internal and external environmental conditions, thus minimizing energy consumption and energy cost.

As discussed above, thermostats have evolved noticeably in recent years. Static programmable thermostats are slowly being replaced by smart thermostats which are more advanced, controllable remotely via user friendly mobile apps, and implement a considerable set of smart features. Examples of such features may include detecting when there are occupants present within a structure (e.g., a house) and adjusting the thermostat temperature setting only as needed, and learning patterns of occupant presence and adjusting the thermostat temperature setting according to the learned patterns. However, despite the recent evolutions introduced by smart thermostats, smart thermostats remain limited in that they do not take into consideration many factors which may influence/impact a desired temperature within the microclimate of a structure. Such factors may include, but are not limited to, various heat generating sources (inside and outside the structure) and their usage/impact patterns, characteristics/attributes of the structure and how they influence the inside temperature of the structure, and occupant habits/preferences. The lack of consideration of factors such as those previously mentioned, results in excessive energy consumption/costs and occupants not satisfied with the temperature of their microclimate. It may therefore be imperative to have a system in place to understand and consider the impact of the building structure characteristics and the various heat generating sources on the microclimate of the structure. Thus, embodiments of the present invention may provide advantages including, but not limited to, predicting and dynamically adjusting the temperature setting of the microclimate based on physical structure response to external and internal environmental conditions, distributing optimized microclimate profiles to connected systems, recommending a best-fit microclimate profile for a new system deployment, dynamically adapting a microclimate profile for a new system deployment, and dynamically refining a microclimate profile based on insights/adaptations from similar matching structures irrespective of location. The present invention does not require that all advantages need to be incorporated into every embodiment of the invention.

According to at least one embodiment, an intelligent microclimate analyzer is proposed that will help reduce the energy costs/consumption by learning the temperature variations in the interior microclimate of a physical structure (e.g., a home or building), this is achieved by monitoring various heat sources (within and/or acting upon the structure) and, over time, identifying their activity patterns and corresponding temperature impacts on the microclimate. The microclimate analyzer then combines those patterns with other factors such as, but not limited to, patterns of occupant presence, patterns of occupant activity, and outside temperature/weather conditions to determine/configure the best settings for the thermostat that will allow the interior microclimate to reach and/or maintain a desired temperature in the most cost-effective manner.

According to at least one other embodiment, over time, the microclimate analyzer generates an adaptive microclimate profile of the interior space which includes information/attributes of the physical structure (e.g., square footage, ceiling height, internal floorplan/blueprint, material composition of the structure, insulation type/material used within the structure, sunrise/sunset geographic orientation, window efficiency information) as well as information about various heat sources within and surrounding the structure (e.g., home appliances, environmental/weather conditions, occupant activity). The generated adaptive microclimate profile analyzes/identifies temperature influences (e.g., an amount of microclimate temperature increase, an amount of heat produced) of the various heat sources, as well as variations in the temperature influences depending on the information/attributes of the structure, to attain a desired temperature within the microclimate of the structure. The generated adaptive microclimate profile may be made available to microclimate analyzer deployments in other, possibly similar, structures to promote an increase is system efficiency through by reducing the learning curve of the system; thus, resulting in additional energy savings.

According to at least one further embodiment, after a learning phase in which one or more microclimate profiles are defined and made available, a best-fit microclimate profile may be assigned to a microclimate analyzer deployment within a physical structure (e.g., a home or building). The assigned microclimate profile may control, via a smart thermostat, temperature settings of a microclimate of the physical structure based on preconfigured information relating to physical structure attributes and heat source temperature influences. Various heat sources of the physical structure may be identified and their respective activity patterns, with correlated temperature influences on the microclimate, may be ascertained. Moreover, attributes of the physical structure may also be identified. In response to ascertaining the heat source activity patterns present for the physical structure, settings of the smart thermostat may be adjusted based on their respective temperature influences on the microclimate and based on identified attributes of the physical structure. Furthermore, the assigned microclimate profile may be adapted based on the ascertained heat source activity patterns and the identified attributes of the physical structure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to adjust thermostat settings for a microclimate based on temperature influencing internal and external conditions.

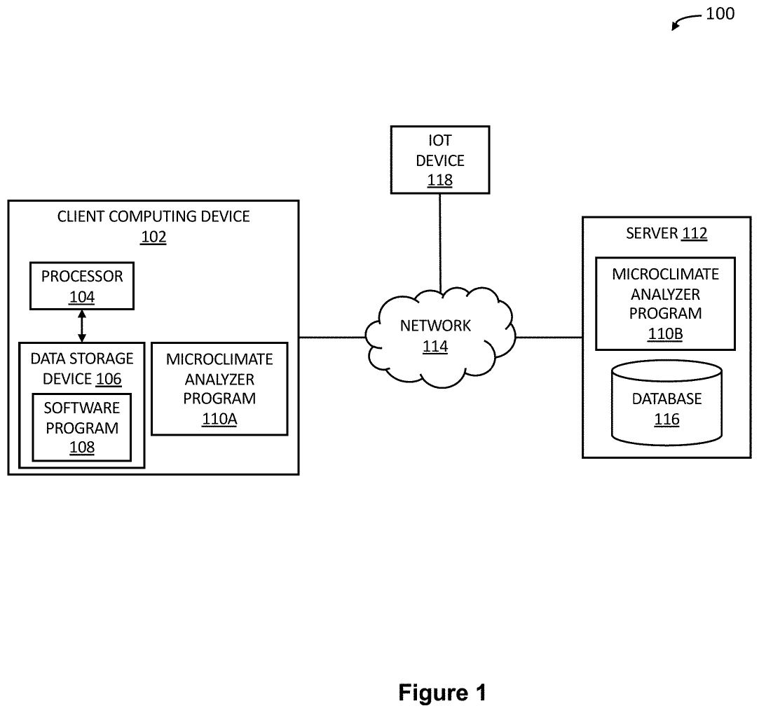

Referring to FIG. 1, an exemplary networked computer environment 100 is depicted, according to at least one embodiment. The networked computer environment 100 may include client computing device 102, a server 112, and Internet of Things (IoT) Device 118 interconnected via a communication network 114. According to at least one implementation, the networked computer environment 100 may include a plurality of client computing devices 102, servers 112, and IoT devices 118, of which only one of each is shown for illustrative brevity. Additionally, in one or more embodiments, the client computing device 102 and the server 112 may each host a microclimate analyzer program 110A, 110B. In one or more other embodiments, the microclimate analyzer program 110A, 110B may be partially hosted on both client computing device 102 and on server 112 so that functionality may be separated among the devices.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

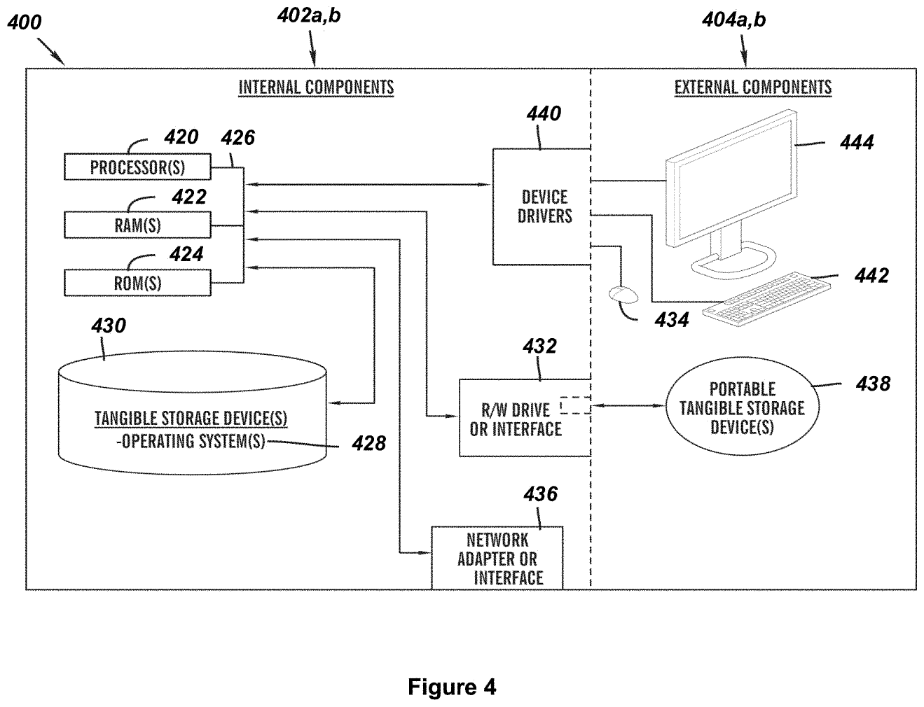

Client computing device 102 may include a processor 104 and a data storage device 106 that is enabled to host and run a software program 108 and a microclimate analyzer program 110A and communicate with the server 112 and IoT Device 118 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. In accordance with one embodiment, client computing device 102 may support a communication link (e.g., wired, wireless, direct, via a LAN, via the network 114, etc.) between IoT device 118 and server 112. Data sent from client computing device 102 may include data collected from and/or observed by IoT device 118. Furthermore, client computing device 102 may also serve to pre-process data received from IoT device 118. Data received by client computing device 102 may include data sent, via network 114, from server 112 and data received from IoT device 118. As will be discussed with reference to FIG. 4, the client computing device 102 may include internal components 402a and external components 404a, respectively.

According to at least one embodiment, software program 108 may be a program, or subroutine contained in a program, that may operate to execute, in part, the functions of client computing device 102 described above. Software program 108 may facilitate the communication between a plurality of IoT devices 118, in addition to the communication between these devices and server 112. According to at least one embodiment, software program 108 may translate potentially different protocols utilized by a plurality of IoT devices 118 into a standard protocol and filter out unnecessary data gathered by the devices. Furthermore, software program 108 may process data received from IoT device 118. Such processing may include actions such as: data caching, buffering and streaming; data pre-processing, cleansing, filtering and optimization; data aggregation; maintaining short term data history, managing user access and network security features; performing IoT device configuration management; and performing system diagnostics.

The server computer 112 may be a laptop computer, netbook computer, personal computer (PC), a desktop computer, or any programmable electronic device or any network of programmable electronic devices capable of hosting and running a microclimate analyzer program 110B and a database 116 and communicating with the client computing device 102 and IoT Device 118 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

IoT Device 118 may be a smart thermostat embedded in or external to the client computing device 102, and/or any other IoT Device 118 known in the art for capturing temperature/heat output and/or detecting occupant presence that is capable of connecting to the communication network 114, and transmitting and receiving data with the client computing device 102 and the server 112. According to some embodiments, IoT device 118 may be any physical IoT device or piece of hardware equipped with one or more sensors and capable of transmitting data over the Internet. Types of devices that IoT device 118 may be include wireless sensors (e.g., temperature sensors, motion sensors, chemical sensors, particle sensors, light sensors, electrical sensors, etc.), software, actuators, and computer devices. IoT device 118 may be imbedded into a plethora of objects including, but not limited to, mobile devices, industrial equipment, home appliances, thermostats, light bulbs, televisions, cameras, environmental sensors, computing devices, wearable computing devices, exercise equipment, and vehicles. IoT device 118 may transmit data over the Internet and/or via other technologies such as radio frequency, a Bluetooth network, a WiFi network, or a combination thereof. According to at least one embodiment, the one or more sensors of IoT device 118 collects data on observable occurrences or changes in a physical environment (e.g., temperature changes, heat output) and/or of a person (e.g., occupant presence). Furthermore, IoT device 118 may transmit collected data to another device, such as client computing device 102. While the exemplary networked computer environment 100 is depicted as having one IoT device 118, in other embodiments, environment 100 may include a cluster or plurality of IoT devices 118, working together or working separately.

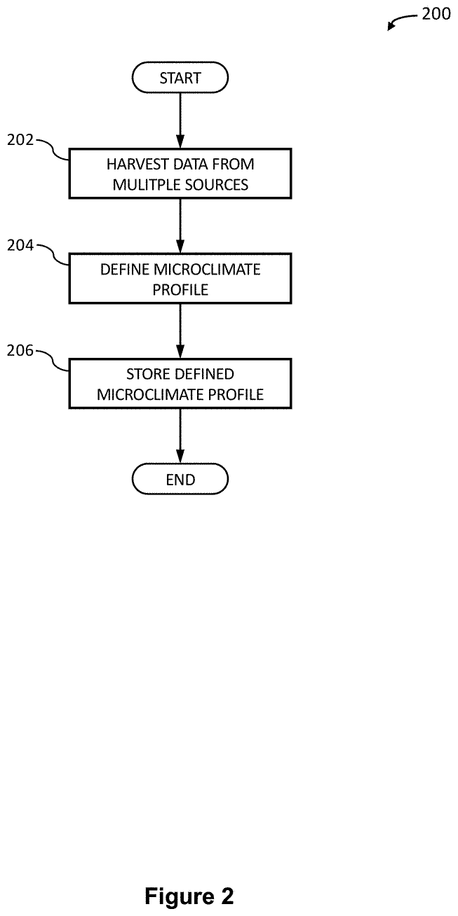

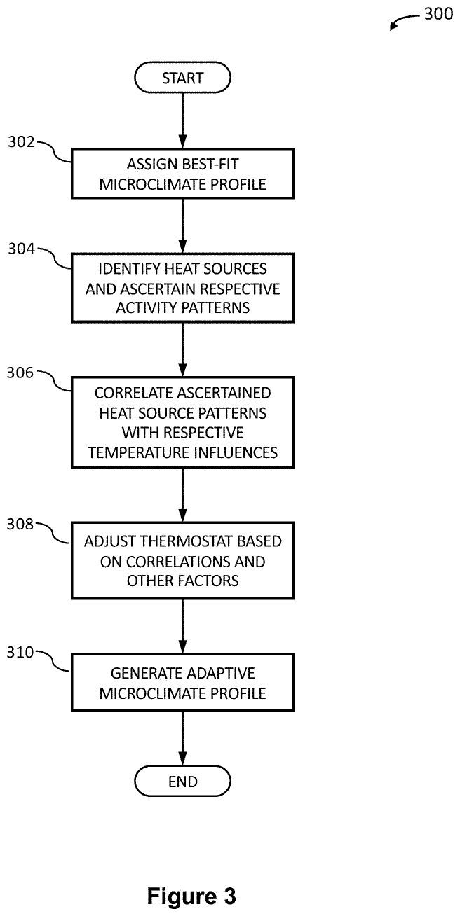

According to the present embodiment, the microclimate analyzer program 110A, 110B may be a program capable of learning/defining one or more microclimate profiles. The microclimate analyzer program 110A, 110B may also be capable of identifying various heat sources, within and/or acting upon, a structure, identifying activity patterns of the identified heat sources, correlating the identified activity patterns with temperature impacts on an interior microclimate of the structure, combining those patterns/correlations with other factors, and adjusting a thermostat of the structure based on the combined activity patterns/correlations and other factors so as to reach or maintain a desired temperature within the interior microclimate. The microclimate profile learning method is explained in further detail below with respect to FIG. 2. The microclimate temperature analyzation method is explained in further detail below with respect to FIG. 3.

Referring now to FIG. 2, an operational flowchart for defining a microclimate profile for a physical structure in a microclimate profile learning process 200 is depicted according to at least one embodiment. At 202, the microclimate analyzer program 110A, 110B is based on an intelligent learning model which harvests data from multiple sources. The data may be collected from sensors within the structure (e.g., from IoT devices present within the structure), retrieved by microclimate analyzer program 110A, 110B from a repository of previously calculated/defined microclimate profiles stored within database 116, and/or received as outside input (e.g., recommendations from energy/utility service providers, information entered by a user of microclimate analyzer program 110A, 110B). The harvested data may include information on:
Occupant activity and/or location: tracking an occupant's location saves energy by adjusting the temperature only when and/or where needed. For example, temperature settings may only need to be adjusted when an occupant is present in a structure. As another example, temperature settings may only need to be adjusted in a particular area of a structure in which an occupant is present. As yet another example, temperature settings may be adjusted in response to detected activity (e.g., sleeping, exercising, cooking) of an occupant. Microclimate analyzer program 110A, 110B may learn (i.e., monitors and tracks) patterns of occupant activity and/or location to configure the desired temperature settings of an interior microclimate of the structure.
A history of desired temperature settings.
Weather conditions: tracking/collecting this data for use in calculating the impact of outside whether conditions on the temperature of the interior microclimate.
Interior heat sources: these may refer to various sources of potential heat that are present within the structure (e.g., stove/oven, toaster oven, microwave, LCD screens, computing devices, clothes dryer, dishwasher) that may be represented my one or more IoT devices 118. Their temperature output may be measured using embedded sensors or calculated by microclimate analyzer program 110A, 110B based on their impact on the temperature of the interior microclimate.
Energy consumption recommendations: these recommendations may be periodically provided by a utility service provider to ensure that electrical appliances, equipment and other devices are functional. These recommendations may be primarily based on severe outside weather conditions.
Walls/Building structure: information collected about the building structure that may be used to calculate the impact on heat retention/loss (e.g., construction materials used in the structure, insulation material used), information collected about the dimensions of structure (e.g., square footage, interior layout, ceiling height).
Windows & sun exposure: information about efficiency ratings of windows of the structure, amount of heat gained/lost through windows of the structure (e.g., IoT sensors on windows which collect and transmit temperature related information).

Then, at 204, the microclimate analyzer program 110A, 110B defines a microclimate profile for the structure based on analysis of the data harvested at 202. The defined microclimate profile may include the harvested data and one or more activity/usage patterns derived, by microclimate analyzer program 110A, 110B, from the harvested data. For each activity/usage pattern, microclimate analyzer program 110A, 110B may identify and correlate the pattern to a temperature impact/influence on the internal microclimate of the structure. According to at least one other embodiment, microclimate analyzer program 110A, 110B may consolidate two or more activity/usage patterns and identify and correlate them to a total temperature impact/influence on the internal microclimate of the structure. The correlated temperature impacts/influences for the activity/usage patterns may also be included in the defined microclimate profile. In deriving the activity/usage patterns and in correlating their respective temperature influences, microclimate analyzer program 110A, 110B may utilize state-of-the-art artificial intelligence (AI) and known machine learning algorithms. According to the present embodiment, microclimate analyzer program 110A, 110B may adjust a smart thermostat of the structure to achieve and/or maintain a desired temperature of the internal microclimate based on the defined microclimate profile.

In the present embodiment, at 206, the microclimate analyzer program 110A, 110B may store the defined microclimate profile within a repository of microclimate profiles hosted by database 116. The defined microclimate profile, as well as the other microclimate profiles of the repository, may be made available as microclimate assignment options for a deployment of microclimate analyzer program 110A, 110B within another structure.

Referring now to FIG. 3, an operational flowchart for adjusting thermostat settings of a microclimate in a microclimate temperature analyzation process process 300 is depicted according to at least one embodiment. At 302, microclimate analyzer program 110A, 110B may assign a best-fit microclimate profile for a physical structure (e.g., a home, a commercial building, an office, a factory). Microclimate analyzer program 110A, 110B may select the best-fit microclimate profile from among the microclimate profiles stored within database 116. The selection of the best-fit microclimate profile may be based on a threshold degree of similarities between information within the best-fit microclimate profile and information of the physical structure provided to microclimate analyzer program 110A, 110B by a user. For example, information within the best-fit microclimate profile and information of the physical structure may indicate a similar geographic location, similar structure attributes and dimensions (e.g., square footage, interior layout, construction materials, insulation type), a similar presence of IoT devices/appliances/computing devices, similar activity/usage patterns, and/or a similar structure occupancy number. Microclimate analyzer program 110A, 110B assigns the microclimate profile which best matches the information of the physical structure. According to at least one other embodiment, if multiple microclimate profiles meet the threshold degree of similarity, microclimate analyzer program 110A, 110B may take average values of their similarities.

Then, at 304, the microclimate analyzer program 110A, 110B identifies various heat sources (internal and external) of the physical structure and identifies their respective activity/usage patterns. The interior temperature of the structure may be subject to and influenced by multiple factors, to achieve the most efficient adjusting of the thermostat microclimate analyzer program 110A, 110B identifies and considers the various factors to generate the desired temperature settings, it accomplishes this by collecting, analyzing and learning the activity/usage patterns of the various factors which may include:
Internal heat sources: Internal heat sources, refer to anything that can generate heat inside the physical structure (e.g., LCD screens, computing devices, cooking appliances, etc.). For the microclimate analyzer program 110A, 110B to learn the various patterns related to those sources, it needs to identify when any internal heat sources are active (this can be achieved using enabled features of IoT appliances or by additional sensors). Microclimate analyzer program 110A, 110B may determine the impact of any internal heat source via the variation in temperature that it may have on the overall internal temperature of the structure and/or via the amount of measured heat output by the source. Although the temperature impact may vary, an activity/usage pattern will be identified overtime.
External heat sources (sunlight exposure and weather conditions): Sunlight is another source of heat, depending on the outside weather, its temperature influence can be significant on the internal temperature of the structure. According to one embodiment, the temperature influence (e.g., generated heat) of sunlight over windows of the structure can be calculated/estimated based on existing mathematical models, this allows microclimate analyzer program 110A, 110B to calculate the heat provided at an instant time (T). According to another embodiment, the temperature influence (e.g., generated heat) of sunlight over windows of the structure can be measured by IoT enabled sensors embedded within or placed upon the windows. Microclimate analyzer program 110A, 110B may log, analyze, and extract the patterns related to sunlight exposure over the windows, and identify their temperature impact over time on the interior temperature of the structure.
Building structure attributes: The building structure is probably the most important factor in heat retention/loss. For example, a brick, wood, or concrete structure will have significant influence on the internal microclimate of the structure. Although the structure itself is not a generator of heat, it plays a role with regard to heat retention/loss, so to identify the structure's temperature influence, microclimate analyzer program 110A, 110B may identify the outside weather conditions. Microclimate analyzer program 110A, 110B may access local weather forecasts and temperatures via the Internet. However, such information would not inform as to precisely what the outside structure temperature is, as this varies depending on the sun exposure & other geographic parameters. As such, microclimate analyzer program 110A, 110B may log variations in the interior temperature of the structure and correlate them (e.g., using regression) to the accessed outside weather conditions and temperatures. As for the internal heat sources, the microclimate analyzer program 110A, 110B may generate over time the activity/usage pattern as affected by the temperature impact of the structure.

In the present embodiment, at 306, the microclimate analyzer program 110A, 110B correlates the identified activity/usage patterns of the various heat sources with their respective temperature influences. Microclimate analyzer program 110A, 110B may identify the temperature influence of any heat source via the variation in temperature that it may have on the overall internal temperature of the structure and/or via the amount of measured heat output by the source. In an ideal learning environment, the microclimate analyzer program 110A, 110B would be input with and evaluate data from each factor (i.e., internal/external heat sources and building structure attributes) once at a time, however this is not a realistic approach. As such, the microclimate analyzer program 110A, 110B must deal with “data entanglement”. Data entanglement refers to the fact that an interior temperature reading of the structure is received as raw data, which is the sum of multiple factors as mentioned earlier (e.g., heat sources, sunlight, retention caused by building structure). To deal with the data entanglement, the microclimate analyzer program 110A, 110B may isolate the sources. In doing so, the microclimate analyzer program 110A, 110B may be aware, when reading an internal temperature of the structure, which factors are active so that any block of data captured (i.e., temperature reading) may be accompanied with flag(s) indicating which sources are active. With the effect of building structure attributes being active all the time, the microclimate analyzer program 110A, 110B can isolate samples of data when other sources are active, for example, comparing a data block (e.g., reading of internal temperature for a period of time) on sunny days vs non-sunny days to determine the additional effect of sunlight.

In the present embodiment, at 308, the microclimate analyzer program 110A, 110B may adjust a thermostat of the structure based on the identified activity/usage patterns, with their respective temperature influence correlations, and other factors (e.g., structure attributes) so as to reach or maintain a desired temperature within the interior microclimate of the structure. Using the activity/usage patterns of the various factors that were analyzed (e.g., heat sources, sunlight exposure) and information of the physical structure, the microclimate analyzer program 110A, 110B may adjust proactively the temperature settings of the thermostat depending on the expected impact any of the factors will have on the temperature of the microclimate within the physical structure. As an illustrative example, consider a scenario in which the microclimate analyzer program 110A, 110B has determined the activity/usage pattern for an oven within the structure, which generates every evening at dinner time an increase of 0.5 degree Celsius in internal temperature of the structure. In response, the microclimate analyzer program 110A, 110B may decrease the thermostat settings accordingly to ensure the temperature of the microclimate within the structure remains at a desired temperature without wasteful energy consumption. As the effect of the oven fades or as the activity/usage pattern for the oven indicates discontinued activity, the microclimate analyzer program 110A, 110B may then increase the thermostat setting, in order to raise the interior temperature and keep the desired interior temperature steady and the transition unnoticeable to the occupant(s).

According to at least one embodiment, to adapt to multiple factors impacting the interior temperature of the structure, the microclimate analyzer program 110A, 110B simply consolidates the various factors and calculates their temperature impact (e.g., a total increased temperature effect), and dynamically adjusts the thermostat settings as any one factor's temperature impact is stopped.

According to at least one other embodiment, the microclimate analyzer program 110A, 110B may adjust a thermostat of the structure to adapt the temperature to match the type of activity performed by the occupants present in a room.

In the present embodiment, at 310, the microclimate analyzer program 110A, 110B may alter the assigned best-fit microclimate profile to generate an adaptive microclimate profile for the physical structure. The microclimate profile assigned at 302 may have been defined at another deployment of the microclimate analyzer program 110A, 110B and may include a history of desired temperature settings and information about the physical structure where the assigned microclimate was defined, such as dimensions/attributes of that physical structure, types of appliances present, and windows and sun exposure. In the present deployment, the microclimate analyzer program 110A, 110B may use the assigned microclimate profile data as a starting point (i.e., a best-fit microclimate profile based on multi-factor similarity assessment) and then perform its own learning & pattern generation. Over time the microclimate analyzer program 110A, 110B in the present deployment may generate “adaptation coefficients”, which indicate the differences between the received activity/usage patterns and temperature impact correlations of the best-fit microclimate profile and the activity/usage patterns and temperature impact correlations later learned (generated) at the physical structure. As an illustrative example, consider a scenario in which the microclimate analyzer program 110A, 110B received a microclimate profile containing the activity/usage patterns of a cooking appliance, and its respective temperature impact on the microclimate of the previous home, assuming the current home is larger than the previous one, the temperature impact will be less and a coefficient for the factor can be calculated. The information of the current home affects the coefficient calculation.

According to at least one embodiment, as microclimate analyzer program 110A, 110B is deployed in a multitude of physical structures, the said adaptation coefficient can be calculated more and more precisely so that new deployments will have an additional level of optimization. Meaning, instead of simply deploying a new microclimate analyzer program 110A, 110B with an existing microclimate profile, the new deployment may also use the calculated coefficient(s) to “adapt” its knowledge base. Following the previous example of cooking appliance, the later deployed microclimate analyzer program 110A, 110B may use the appliance coefficient to calculate the potential impact of the cooking appliance more precisely. While it is impossible to eliminate the learning curve in the new deployment, simply because the chances to have all factors equal are nearly impossible (e.g., same interior space, same structure, same geographic conditions, same appliances deployed, same furniture etc.), it is possible to reduce the learning curve drastically for the new deployment using the combination of an existing set of data patterns (i.e., an existing microclimate profile) and their adaptive coefficients. The performance and efficiency metric for microclimate analyzer program 110A, 110B may be energy/utility cost. Energy savings should theoretically follow an opposite curve to the learning curve, meaning as the learning curve decreases and microclimate analyzer program 110A, 110B becomes more and more efficient, the energy savings will be greater. According to at least one embodiment, the microclimate analyzer program 110A, 110B may monitor the monthly energy/utility cost of the physical structure.

It may be appreciated that FIGS. 2 and 3 provide only an illustration of one implementation and do not imply any limitations with regard to how different embodiments may be implemented. Many modifications to the depicted environments may be made based on design and implementation requirements.

According to at least one embodiment, the microclimate analyzer program 110A, 110B may be scaled (extended) to support additional heat factors, if it can capture or calculate the heat generated by those factors, analyze it, and generate its activity/usage patterns as described above. For example, in a scenario where multiple apartments share a common structure, each apartment can be a “factor” of heat to its neighbors, it is possible to capture via sensors the heat generated, calculate its impact on the interior temperature, and adapt to it, as described above. Although the microclimate analyzer program 110A, 110B has been described in residential deployments, it can be repurposed for an implementation in industrial or commercial spaces as well and heat factors could include, for example, heavy machinery, computing devices, and density of population.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the microclimate analyzer program 110A in the client computing device 102 and the microclimate analyzer program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the microclimate analyzer program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the microclimate analyzer program 110A in the client computing device 102 and the microclimate analyzer program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the microclimate analyzer program 110A in the client computing device 102 and the microclimate analyzer program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

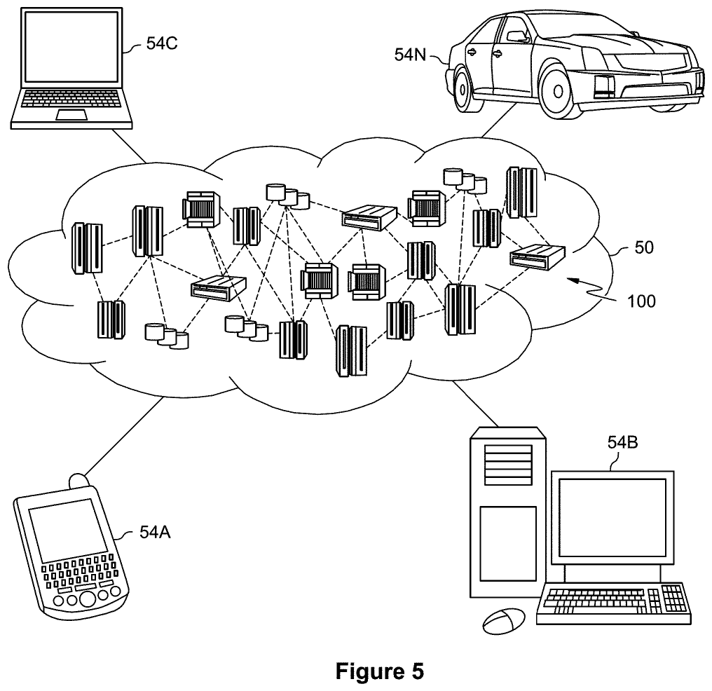

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

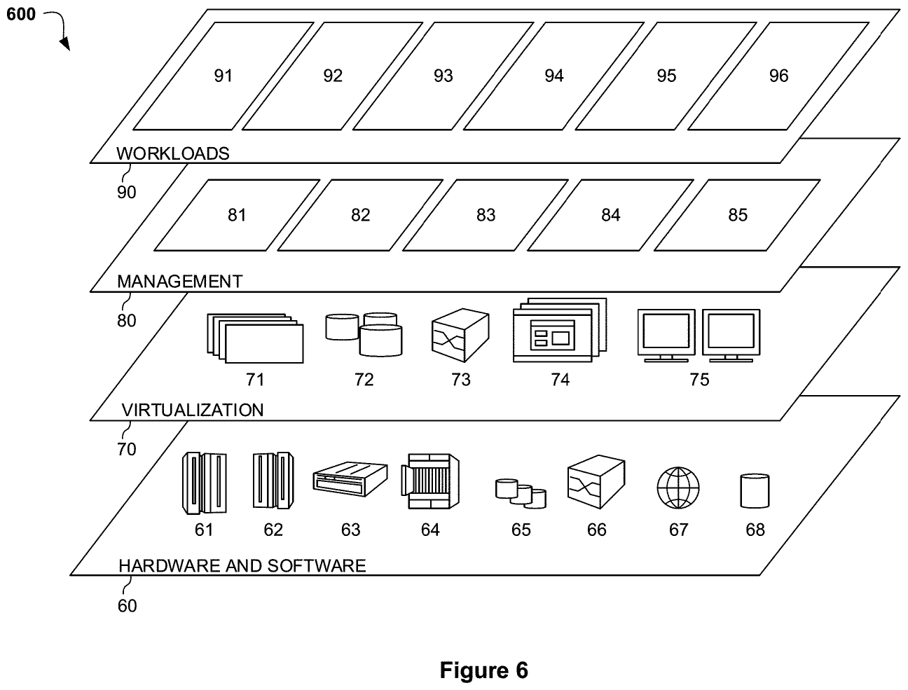

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and microclimate analysis 96. Microclimate analysis 96 may relate to adjusting a thermostat of a physical structure based on analysis of internal/external heat sources of the structure and other information of the structure.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of adjusting a microclimate of a structure, the method comprising:
assigning a best-fit microclimate profile for the structure;
identifying heat sources of the structure and respective activity patterns of each identified heat source;
correlating each identified activity pattern to a respective temperature influence on the microclimate; and
adjusting a thermostat of the structure based on the identified activity patterns with correlated temperature influences and other factors, wherein the thermostat controls temperature settings for the microclimate.

2. The method of claim 1, wherein assignment of the best-fit microclimate profile is based on a threshold of similarity between information of the best-fit microclimate profile and information of the structure.

3. The method of claim 1, wherein heat sources of the structure comprise internal and external heat sources.

4. The method of claim 1, wherein the other factors comprise attribute information of the structure.

5. The method of claim 1, further comprising:
altering the best-fit microclimate profile to generate an adaptive microclimate profile for the structure; and
storing the adaptive microclimate profile in a repository of microclimate profiles.

6. The method of claim 5, wherein the adaptive microclimate profile comprises one or more adaptation coefficients which indicate the differences between activity patterns and temperature influence correlations of the assigned best-fit microclimate profile and the identified activity patterns with correlated temperature influences.

7. The method of claim 1, further comprising:
monitoring a monthly utility cost of the structure.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
assigning a best-fit microclimate profile for the structure;
identifying heat sources of the structure and respective activity patterns of each identified heat source;
correlating each identified activity pattern to a respective temperature influence on the microclimate; and
adjusting a thermostat of the structure based on the identified activity patterns with correlated temperature influences and other factors, wherein the thermostat controls temperature settings for the microclimate.

9. The computer system of claim 8, wherein assignment of the best-fit microclimate profile is based on a threshold of similarity between information of the best-fit microclimate profile and information of the structure.

10. The computer system of claim 8, wherein heat sources of the structure comprise internal and external heat sources.

11. The computer system of claim 8, wherein the other factors comprise attribute information of the structure.

12. The computer system of claim 8, further comprising:
altering the best-fit microclimate profile to generate an adaptive microclimate profile for the structure; and
storing the adaptive microclimate profile in a repository of microclimate profiles.

13. The computer system of claim 12, wherein the adaptive microclimate profile comprises one or more adaptation coefficients which indicate the differences between activity patterns and temperature influence correlations of the assigned best-fit microclimate profile and the identified activity patterns with correlated temperature influences.

14. The computer system of claim 8, further comprising:
monitoring a monthly utility cost of the structure.

15. A computer program product, the computer program product comprising:
one or more computer-readable tangible storage medium and program instructions stored on at least one of the one or more tangible storage medium, the program instructions executable by a processor capable of performing a method, the method comprising:
assigning a best-fit microclimate profile for the structure;
identifying heat sources of the structure and respective activity patterns of each identified heat source;
correlating each identified activity pattern to a respective temperature influence on the microclimate; and
adjusting a thermostat of the structure based on the identified activity patterns with correlated temperature influences and other factors, wherein the thermostat controls temperature settings for the microclimate.

16. The computer program product of claim 15, wherein assignment of the best-fit microclimate profile is based on a threshold of similarity between information of the best-fit microclimate profile and information of the structure.

17. The computer program product of claim 15, wherein heat sources of the structure comprise internal and external heat sources.

18. The computer program product of claim 15, wherein the other factors comprise attribute information of the structure.

19. The computer program product of claim 15, further comprising:
altering the best-fit microclimate profile to generate an adaptive microclimate profile for the structure; and
storing the adaptive microclimate profile in a repository of microclimate profiles.

20. The computer program product of claim 19, wherein the adaptive microclimate profile comprises one or more adaptation coefficients which indicate the differences between activity patterns and temperature influence correlations of the assigned best-fit microclimate profile and the identified activity patterns with correlated temperature influences.
